(19) United States
(12) Patent Application Publication
(10) Pub. No.: US 2021/0127367 A1
(43) Pub. Date: Apr. 29, 2021

(54) METHOD AND APPARATUS FOR ALLOCATING RESOURCE IN WIRELESS COMMUNICATION SYSTEM

(71) Applicant: LG Electronics Inc., Seoul (KR)

(72) Inventor: Yunjung Yi, Seoul (KR)

(21) Appl. No.: 16/605,879

(22) PCT Filed: Apr. 20, 2018
(86) PCT No.: PCT/KR2018/004598

§ 371 Date: Oct. 17, 2019

Related U.S. Application Data
(60) Provisional application No. 62/488,038, filed on Apr. 20, 2017.
(60) Provisional application No. 62/521,355, filed on Jun. 16, 2017.
(60) Provisional application No. 62/577,150, filed on Oct. 25, 2017.
(60) Provisional application No. 62/588,310, filed on Nov. 17, 2017.

(51) Int. Cl. H04W 72/04

(52) U.S. Cl. CPC H04W 72/042; H04W 72/0453

(57) ABSTRACT

Provided is a method for transmitting fallback downlink control information (DCI) in a wireless communication system. A base station (BS) determines a bandwidth for the fallback DCI, which relates to a change between a plurality of bandwidth parts (BWPs) configured for a user equipment (UE), transmits information on the bandwidth for the fallback DCI to the UE, and transmits the fallback DCI to the UE through the bandwidth for the fallback DCI. From the viewpoint of a UE, the bandwidth for the fallback DCI is independently determined regardless of sizes and locations of the BWPs configured for the UE.

### TECHNICAL FIELD

The present disclosure relates to wireless communications, and more particularly to a method and an apparatus for allocating resources in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

As more communication devices require great communication capacity, a demand with respect to enhanced mobile broadband (eMBB) communication is spotlighted. Further, there is a main issue that a plurality of devices and objects are connected so that large machine type communication (MTC) providing various services regardless of time and location to be considered as next generation communication. Further, ultra-reliable and low latency communication (URLLC) considering service/user equipment (UE) sensitive to reliability and delay has been discussed. As described above, introduction of a next generation radio access technology considering eMBB, a large MTC, URLLC has been discussed. For convenience of the description, such new radio access technology may refer to a new radio access technology (NR).

A wavelength is short in a millimeter wave (mmW) so that a plurality of antennas may be installed at the same area. For example, the wavelength is 1 cm at a 30 GHz band, total 100 antenna elements may be installed in a secondary arrangement form at 0.5λ (wavelength) on a panel of 5×5 cm2. Accordingly, a plurality of antenna elements is used at the mmW band so that a beamforming gain is increased to increase coverage or a throughput.

In this case, if a transceiver is included to adjust transmission power and a phase by antenna element, an independent beamforming is possible by frequency resource. However, if transceivers are installed at 100 antenna elements, respectively, the effectiveness is deteriorated in a cost side. Accordingly, it is considered that a plurality of antenna elements are mapped to one transceiver and a direction of a beam are adjusted to an analog phase shifter. Such an analog beamforming scheme can create only one beam direction so that a frequency selective beamforming cannot be performed.

A hybrid beamforming having B transceivers having the number less than Q antenna elements in an intermediate form of digital beamforming and analog beamforming may be considered. In this case, although the number of direction of the beam capable of being simultaneously transmitted is changed according to a connection scheme of B transceivers and Q antenna elements, the number of direction of the beam is limited to less than B.

According to unique characteristics of NR, a structure of a physical channel and/or related characteristics of NR may be different from those of an existing LTE. For an efficient operation of the NR, various schemes may be suggested.

### SUMMARY

The present disclosure provides a method and an apparatus for allocating resources in a wireless communication system. The present disclosure discusses resource allocation and downlink control information (DCI) design in consideration of bandwidth adaptation and broadband/narrowband operation in NR. More specifically, the present disclosure provides a method and an apparatus for allocating, by a network, fallback downlink control information (DCI) for a UE.

In an aspect, a method for transmitting a fallback downlink control information (DCI) by a base station in a wireless communication system is provided. The method includes determining a bandwidth for the fallback DCI related to a change between a plurality of bandwidth parts (BWPs) configured for a user equipment (UE), transmitting information on the bandwidth for the DCI to the UE, and transmitting the fallback DCI to the UE through the bandwidth for the fallback DCI.

In another aspect, a method for receiving fallback downlink control information (DCI) by a user equipment (UE) in a wireless communication system is provided. The method includes receiving information on a bandwidth for the fallback DCI from a network, receiving the fallback DCI from the network through the bandwidth for the fallback DCI. The bandwidth for the DCI is determined regardless of sizes and locations of a bandwidth parts (BWPs) of the UE.

It is possible for a UE to receive fallback DCI reliably.

### BRIEF DESCRIPTION OF THE DRAWINGS

FIG. 1 shows a NG-RAN architecture.

FIG. 2 shows an example of a subframe structure in an NR.

FIG. 3 shows a time-frequency structure of an SS block.

FIG. 4 shows an example of a system bandwidth and a bandwidth supported from the UE in an NR carrier.

FIG. 5 shows an example of carrier aggregation.

FIG. 6 shows a method for determining the center of a UE receiver according to an embodiment of the present disclosure.

FIG. 7 shows a case where a BWP is changed according to an embodiment of the present disclosure.

FIG. 8 shows a case where a BWP is changed according to another embodiment of the present disclosure.

FIG. 9 shows a method for transmitting fallback DCI by a base station according to an embodiment of the present disclosure.

FIG. 10 shows a method for receiving fallback DCI by a UE according to an embodiment of the present disclosure.

FIG. 11 shows an example in which different UEs are configured with different bandwidths in a carrier according to an embodiment of the present disclosure.

FIG. 12 shows a wireless communication system in which an embodiment of the present disclosure is implemented.

FIG. 13 shows a processor of a UE shown in FIG. 12.

### DETAILED DESCRIPTION

Hereinafter, the following description will be made while focusing on an NR based wireless communication system. However, the present disclosure is limited thereto. The present disclosure is applicable to another wireless communication system, for example, 3rd generation partnership project (3GPP) long-term evolution (LTE)/LTE-A(advanced) or institute of electrical and electronics engineers (IEEE) having the same characteristic to be described below.

A 5G system is a 3GPP system including a 5G access network (AN), a 5G core network (CN) and user equipment (UE). The UE may be called other terms such as a mobile station (MS), a user terminal (UT), a subscriber station (SS), or a wireless device. A 5G AN is an access network including a non-3GPP access network and/or a new generation radio access network (NG-RAN) connected to the 5G CN. The NG-RAN is a wireless access network having a common characteristic connected to the 5G CN and for supporting at least one of following options.

1) Independent type new radio (NR).

2) The NR is an anchor having E-UTRA extension.

3) Independent type E-UTRA.

4) An E-UTRA is an anchor having NR extension.

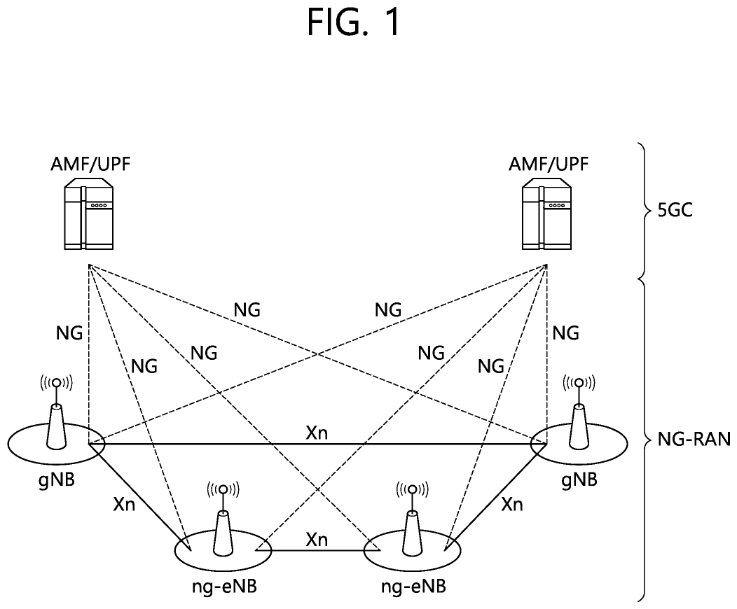

FIG. 1 shows a NG-RAN architecture. Referring to FIG. 1, the NG-RAN includes at least one NG-RAN node. The NG-RAN node includes at least one gNB and/or at least one ng-eNB. A gNB/ng-eNB may be called a base station (BS) or an access point. A gNB provides an NR user plane and a control plane protocol termination toward the UE. An ng-eNB provides an E-UTRA user plane and a control plane protocol termination toward the UE. A gNB is connected with an ng-eNB through an Xn interface. The gNB and the ng-eNB are connected with the 5G CN through the NG interface. In detail, the gNB and the ng-eNB are connected with an access and mobility management function (AMF) through an NG-C interface, and are connected with a user plane function (UPF) through an NG-U interface.

The gNB and/or ng-eNB host the following functions:
Functions for radio resource management: Radio bearer control, radio admission control, connection mobility control, dynamic allocation of resources to UEs in both uplink and downlink (scheduling);
Internet protocol (IP) header compression, encryption and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or operations & maintenance (O&M));
Measurement and measurement reporting configuration for mobility and scheduling;
Transport level packet marking in the uplink;
Session management;
Support of network slicing;
Quality of service (QoS) flow management and mapping to data radio bearers;
Support of UEs in RRC_INACTIVE state;
Distribution function for non-assess stratum (NAS) messages;
Radio access network sharing;
Dual connectivity;
Tight interworking between NR and E-UTRA.

The AMF hosts the following main functions:
NAS signaling termination;
NAS signaling security;
AS security control;
Inter CN node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing;
Session management function (SMF) selection.

The UPF hosts the following main functions:
Anchor point for Intra-/Inter-radio access technology (RAT) mobility (when applicable);
External protocol data unit (PDU) session point of interconnect to data network;
Packet routing & forwarding;
Packet inspection and user plane part of policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink traffic verification (service data flow (SDF) to QoS flow mapping);
Downlink packet buffering and downlink data notification triggering.

The SMF hosts the following main functions:
Session management;
UE IP address allocation and management;
Selection and control of UP function;
Configures traffic steering at UPF to route traffic to proper destination;
Control part of policy enforcement and QoS;
Downlink data notification.

In the NR, a plurality of orthogonal frequency division multiplexing (OFDM) numerologies may be supported. A plurality of numerologies may be mapped to different subcarrier spacings, respectively. For example, a plurality of numerologies mapped to various subcarrier spacings of 15 kHz, 30 kHz, 60 kHz, 120 kHz, and 240 kHz may be supported.

Downlink (DL) transmission and uplink (UL) transmission are configured in a frame having a length of 10 ms in the NR. One frame includes 10 subframes having a length of 1 ms. Each frame is divided into two half-frames having the same size. A half-frame 0 is configured by subframes 0-4. A half-frame 1 is configured by subframes 5-9. In a carrier, one frame group is included on UL and one frame group is included on DL.

A slot is configured by each numerology in the subframe. For example, in a numerology mapped to a subcarrier spacing of 15 kHz, one subframe includes one slot. In a numerology mapped to a subcarrier spacing of 30 kHz, one subframe includes two slots. In a numerology mapped to a subcarrier spacing of 60 kHz, one subframe includes four slots. In a numerology mapped to a subcarrier spacing of 120 kHz, one subframe includes eight slots. In a numerology mapped to a subcarrier spacing of 240 kHz, one subframe includes 16 slots. The number of OFDM symbols per slot may maintain 14. A start point of a slot in the subframe may be arranged in a start point of an OFDM symbol in time.

In the slot, the OFDM symbol may be classified into a DL symbol, a UL symbol, or a flexible symbol. In the DL slot, it may be assumed that DL transmission occurs in only a DL symbol or a flexible symbol. In the UL slot, the UE may perform UL transmission in only the UL symbol or the flexible symbol.

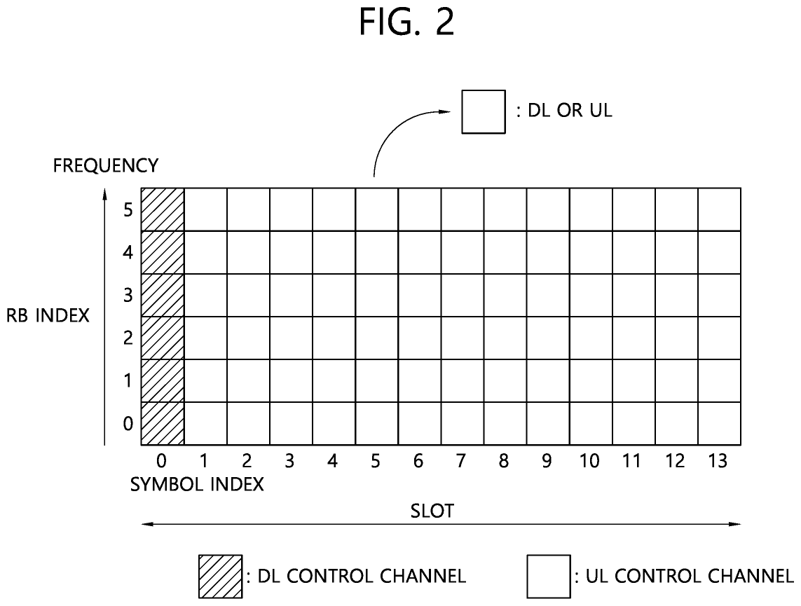

FIG. 2 shows an example of a subframe structure in an NR. The subframe structure of FIG. 2 may be used in a time division duplex (TDD) of the NR in order to minimize transmission delay of data. The subframe structure of FIG. 2 may be called a self-contained subframe structure.

Referring to FIG. 2, a first symbol of a subframe includes a DL control channel, and a final symbol includes a UE control channel Symbols from a second symbol to a thirteenth symbol of the subframe may be used for DL data transmission or UL data transmission. As described above, when DL transmission and UL transmission are sequentially performed in one subframe, the UE may receive DL data and transmit UL hybrid automatic repeat request (HARQ)-acknowledgement (ACK) in one subframe. Finally, a time taken for retransmission upon generation of data transmission error may be reduced. Accordingly, transfer delay of final data may be minimized. In such a subframe structure, a base station and the UE may need a gap to convert a transmission mode into a reception mode or from the reception mode into the transmission mode. To this end, a partial symbol of a time point converted from DL to UL in the subframe structure may be configured as a guard period (GP).

A physical channel in the NR is described.

An antenna port is defined so that a channel on which a symbol is transported on the antenna port may be inferred from a channel on which a different symbol is transported on the same antenna port. If a large-scale characteristic of a channel to which a symbol is transferred on one antenna port may be inferred from a channel to which the symbols is transferred on a different antenna port, two antenna ports may have quasi co-located (QCL) relation to each other. The large-scale characteristic includes at least one of delay spread, Doppler diffusion, Doppler shift, average gain, average delay, and space reception parameter.

With respect to each numerology and carrier, a resource grid consisting of a plurality of subcarriers and a plurality of OFDM symbols is defined. The resource grid starts from a specific common resource block indicated by higher layer signaling. There is one resource grid per antenna port, per numerology, and per transmission direction (DL or UL). Per antenna port and per numerology, each element in the resource grid is called resource element (RE).

The resource block (RB) is defined as 12 continuous subcarriers at a frequency domain. A reference RB starts from 0 at a frequency domain to be indexed in a gradually increased direction. A subframe 0 of the reference RB is common in all numerologies. A subcarrier of an index 0 of the reference RB functions as a common reference point with respect to another RB grid. A common RB starts from 0 at a frequency domain with respect to each numerology to be indexed in a gradually increased direction. A subcarrier having an index 0 of a common RB having index 0 corresponds to a subcarrier having index 0 of the reference RB in each numerology. A physical RB (PRB) and a virtual RB are defined in a bandwidth part (BWP), and starts from 0 in the BWP to be indexed in a gradually increased direction.

The BWP is defined as a continuous group of a selected PRB in a continuous group of common RBs in a given carrier and a given numerology. The UE may be configured with maximum 4 BWPs in DL, and only one DL BWP may be activated at a given time point. It is expected that the UE does not receive a physical downlink shared channel (PDSCH), a physical downlink control channel (PDCCH), a channel state information reference signal (CSI-RS) or a tracking RS (TRS) at an outside of an activated BWP. Further, the UE may be configured with maximum 4 BWPs in UL, and only one UL BWP may be activated at a given time point. When the UE is configured with a supplemental UL (SUL), the UE may be configured with maximum 4 BWPs in SUL, and only one UL BWP may be activated at a given time point. The UE cannot transmit a physical uplink shared channel (PUSCH) or a physical uplink control channel (PUCCH) at an outside of an activated BWP.

In a DL transmission scheme at the NR, a closed loop demodulation RS (DM-RS) based spatial multiplexing is supported for a PDSCH. Maximum 8 and 12 orthogonal DL DM-RS ports support type 1 and type 2 DM-RSs, respectively. Maximum 8 orthogonal DL DM-RS ports are supported per UE with respect to single-user multiple-input multiple-output (SU-MIMO). Maximum 4 DL DM-RS ports per UE are supported with respect to multi-user MIMO (MU-MIMO). The number of SU-MIMO code-words is 1 with respect to 1-4 layer transmission and 2 with respect to 5-8 layer transmission.

The DM-RS and a corresponding PDSCH are transmitted using the same pre-coding matrix, and the UE does not need to know a pre-coding matrix in order to demodulate transmission. A transmitter may use different pre-coder matrixes with respect to different parts of a transmission bandwidth that results in a frequency selective pre-coding. Further, the UE may assume that the same pre-coding matrix is used through a group of PRBs called pre-coding RB group.

DL physical layer processing of a transmission channel is configured by following steps:
Transmission block cyclic redundancy check (CRC) attach;
Code block division and code block CRC attachment;
Channel coding: low-density parity-check (LDPC) coding;
Physical layer hybrid HARQ processing and rate matching;
Bit interleaving;
Modulation: quadrature phase shift keying (QPSK), 16 quadrature amplitude modulation (QAM), 64-QAM and 256-QAM;
Layer mapping and pre-coding;
Mapping to an assigned resource and an antenna port.

The UE may assume that at least one symbol having a DM-RS is included in each layer in which a PDSCH is transmitted to the UE. The number of DM-RS symbols and resource element mapping are configured by a higher layer. A TRS may be transmitted on an additional symbol in order to assist receiver phase track.

The PDCCH is used to schedule DL transmission on the PDSCH and UL transmission on the PUSCH. Downlink control information (DCI) on the PDCCH include following information.
DL assignment including at least modulation and coding scheme, resource assignment and HARQ information associated with DL shared channel (DL-SCH);
UL scheduling grant including at least modulation and coding scheme, resource assignment and HARQ information associated with UL shared channel (UL-SCH).

A control channel is formed by a group of control channel elements, and each control channel element consists of a set of resource element groups. Different numbers of control channel elements are collected so that different code rates with respect to the control channel are configured. Polar coding is used for the PDCCH. Each resource element group transporting the PDCCH transports a DM-RS thereof. QPSK modulation is used for the PDCCH.

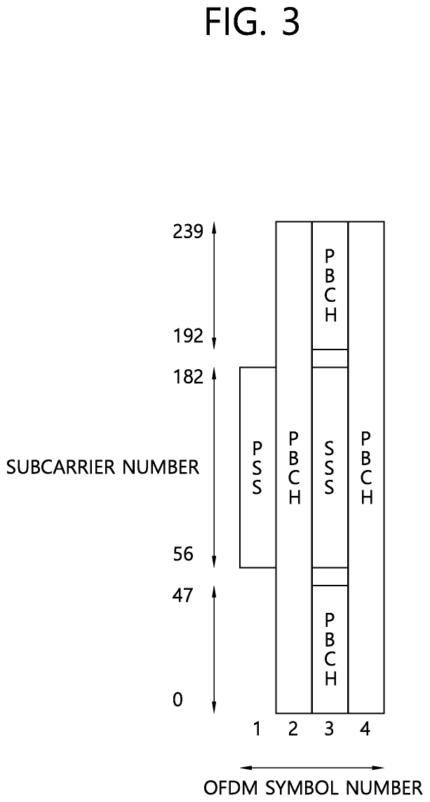

FIG. 3 shows a time-frequency structure of an SS block. A synchronization signal and a physical broadcast channel (PBCH) block (hereinafter referred to as, ‘SS block’) consists of a primary synchronization signal (PSS) and a secondary synchronization signal (SSS), occupying 1 symbol and 127 subcarriers respectively, and a PBCH, which is configured by three symbols and 240 subcarriers but which leaves a unused part at a middle on one symbol for the SSS. A transmission period of the SS block may be determined by a network, and a time position to which the SS block is transmitted is determined by a subcarrier spacing.

Polar coding is used at the PBCH. Unless the network configures different subcarrier spacings to the UE, the UE may assume a band specific subcarrier spacing for the SS block. A PBCH symbol transports frequency multiplexed DM-RS thereof. QPSK modulation is used for the PBCH.

When supported by the network, a wideband may be used in NR. Further, in the NR, a bandwidth supported from the network may differ from a bandwidth supported from the UE. In this case, there is a need to clearly define how to performing transmission and/or reception between the network and the UE.

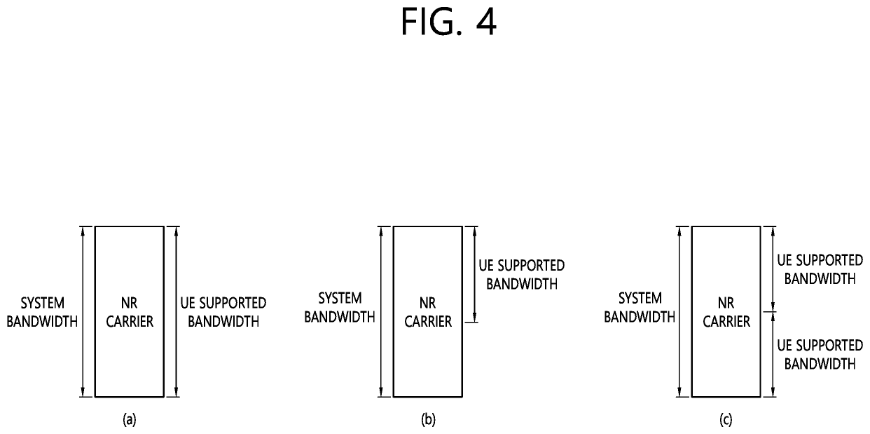

FIG. 4 shows an example of a system bandwidth and a bandwidth supported from the UE in an NR carrier. It is assumed in FIG. 4 that a bandwidth supported from a network is a system bandwidth. However, according to a required system bandwidth, the network may combine an NR carrier. Further, the bandwidth supported from the UE may correspond to the BWP mentioned above. FIG. 4-(a) shows a case where the system bandwidth is the same as the bandwidth supported from the UE. FIG. 4-(b) shows a case where the system bandwidth differs from the bandwidth supported from the UE. In FIG. 4-(b), the bandwidth supported from the UE may be less than the system bandwidth or the bandwidth supported from the UE may be greater than the system bandwidth. FIG. 4-(c) shows a case where the UE support a wideband using a plurality of radio frequency (RF) elements. Accordingly, the system bandwidth may be the same as the bandwidth supported from the UE. A plurality of RF elements may share a baseband element. An individual baseband element may be assigned in a unit of each RF element. It is assumed in the present specification that a plurality of RF elements may share a baseband element/ability. The above may depend on UE ability.

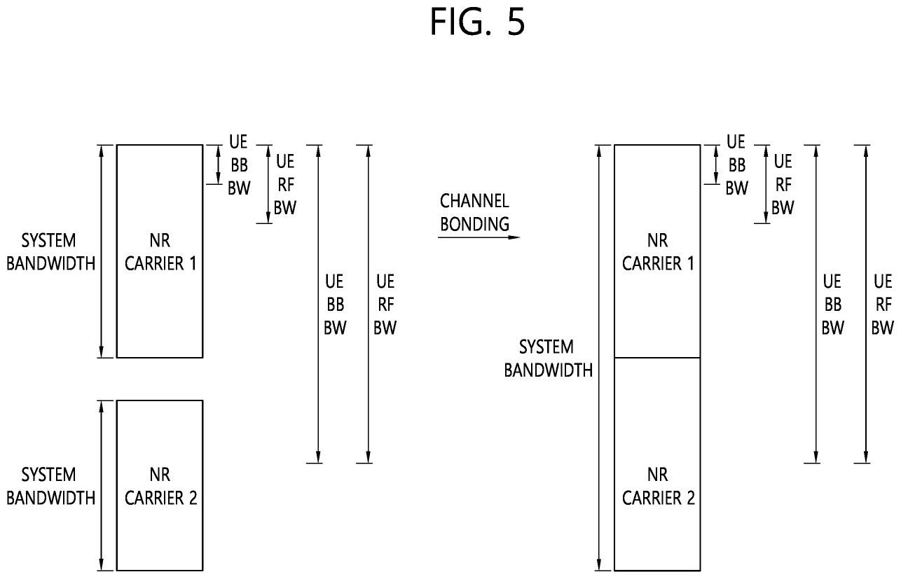

FIG. 5 shows an example of carrier aggregation. If a plurality of NR carrier is aggregated to configure one carrier, the system bandwidth may be changed and a center frequency may be changed. However, a direct current (DC) subcarrier may be changed or may not be changed according to an operation of the network. When the DC subcarrier is changed, the DC subcarrier may be indicated to the UE to suitably process the DC subcarrier.

A UE-specific system bandwidth may be allocated to a UE. The following may be considered to allocate a UE-specific system bandwidth.

(1) A carrier can be divided into a set of minimum subbands (M-SB). The set of M-SB may be configured for a UE by UE-specific signaling.

(2) The first frequency location and the last frequency location of a UE-specific system bandwidth may be configured for the UE by the UE-specific signaling.

(3) The carrier may be divided into a set of PRBs. The set of PRBs may be configured for the UE by the UE-specific signaling.

The carrier may be divided into a set of PRB groups. The set of PRB groups may be configured for the UE by UE-specific signaling. A PRB group may be comprised of M PRBs that are allowed to be positioned contiguously. A size of the M PRBs may be selected to be identical to a size of one PRB based on a greatest subcarrier spacing supported by the carrier. A set of PRB groups may be the same concept as the aforementioned BWP.

When a set of M-SBs, a set of PRBs, or a set of PRB groups is used for a UE-specific bandwidth, the set of M-SBs, the set of PRBs, or the set of PRB groups may be configured based on a reference numerology or a default numerology. The reference numerology or the default numerology may be a numerology used for an SS block, may be predetermined, or may be explicitly or implicitly configured through system information block (SIB), master information block (MIB), or the like.

When carrier aggregation is applied, a system bandwidth may be updated through SIB/MIB or the like. As described above, a center frequency or a DC subcarrier may be also updated through SIB, MIB or the like

For convenience of explanation, it is presumed that a carrier is comprised of M PRBs. The M PRBs may be based on a reference numerology or a default numerology.

In NR, a UE may be required to change its own bandwidth in various scenarios. At this point, a UE-specific configured bandwidth may be the aforementioned BWP. A BWP may be configured for each RE If the UE has a plurality of RFs, the UE may be configured with a plurality of BWP respectively for the plurality of RFs.

In order to deal with a situation in which a BWP, which is a UE-specific bandwidth, changes dynamically, it is necessary to clearly define various aspects, for example, the center frequency (in each of transmitter and receiver aspects), resource allocation, data scrambling, DCI design, etc. In addition, it is also necessary to clearly define how to process common control signal/data, UE-specific control signal/data, group common control signal/data (e.g., multicast control signal/data), and the like.

Hereinafter, various aspects of the present disclosure will be described.

1. Center Frequency of UE.

When PSS/SSS is read, the last point or the start point of a PSS/SSS sequence may be assumed to be the center of a UE receiver. It is to minimize a receiver direct current (DC) effect in receiving PSS/SSS because it may be necessary to increase a bandwidth in order to receive a PBCH.

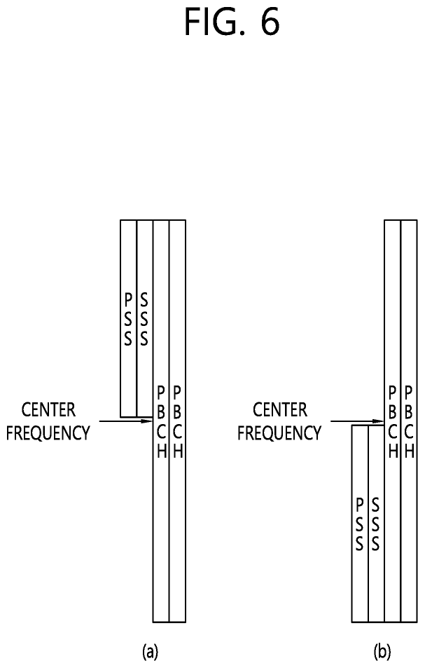

FIG. 6 shows a method for determining the center of a UE receiver according to an embodiment of the present disclosure. In FIG. 6, a size of an SS block is 24 PRBs, and 24 PRBs is comprised of 1) 12 PRBs, 2) DC subcarrier (1 subcarrier), and 3) 12 PRB-1 subcarrier. In FIG. 6-(a), PSS/SSS may be mapped to the first 12 PRBs. Accordingly, the center of the UE receiver may be the last point of a PSS/SSS. In FIG. 6-(b), PSS/SSS may be mapped to the last 12 PRBs-1 subcarrier. Accordingly, the center of the UE receiver may be the start point of a PSS/SS S. Meanwhile, a transmitter DC effect may take place during PSS/SSS transmission according to a location of PSS/SSS with respect to the center frequency. In FIG. 6-(a), with respect to a sync raster, a UE may read 12 PRB of a low frequency domain (with or without including a receiver DC subcarrier). In FIG. 6-(b), with respect to a sync raster, a UE may read 12 PRBs of a high frequency domain (with or without including a receiver DC subcarrier). Or, a channel raster or a sync rater may be based on the center of PSS/SSS. However, in order to allow a UE to adjust a receiver DC subcarrier according to the last point or the start point of PSS/SSS, a PBCH may extend as shown in FIG. 6-(a) and FIG. 6-(b).

The center frequency of a receiver may be adjusted based on a requested bandwidth to receive minimum SI. In such a case, a receiver DC subcarrier may be always determined based on the center of a configured bandwidth (that is, BWP), regardless of a UE bandwidth capability. The configured bandwidth may be cell-specific configured through PBCH/SIB or may be UE-specific configured through higher layer signaling. When a UE has both a cell-specific configured bandwidth and a UE-specific configured bandwidth, the UE-specific configured bandwidth may have a priority, and accordingly, a receiver DC subcarrier may be defined/determined based on the center of the UE-specific configured bandwidth. Similarly, a transmitter DC subcarrier for UL transmission may be also determined based on a UE-specific bandwidth configuration. In a case where a UE uses a transmitter DC subcarrier for a specific reason such as a sidelink operation, dual connectivity, etc., which is different from a DC subcarrier expected by a UE specific bandwidth configuration, the UE may inform a network of such use.

2. Resource Allocation

In general, resource allocation may be performed within a UL bandwidth (BWP) that is configured with respect to at least a UE-specific search space (USS). It may be necessary to define a common search space (CSS) clearly. Meanwhile, by adjusting a size of a RB, an actual size of a resource allocation field may be maintained to be the same, regardless of a system bandwidth. Hereinafter, various aspects of resource allocation according to the present disclosure will be described.

(1) Resource allocation for minimum system information (SI) transmission: A size of a bandwidth for minimum SI transmission may be one of the following.
An SS block size or a minimum system bandwidth (when any other configuration is not given)
The same size as a control resource set (CORESET) for scheduling minimum SI: when there are one or more CORESETs for minimum SI transmission, a bandwidth for minimum SI transmission may be a total set bandwidth of the one or more CORESETs. The total set bandwidth may include a PRB which does not belong to the CORESETs but located between the CORESETs.
A size of a bandwidth that is explicitly configured for data transmission
A system bandwidth (when UE knows the system bandwidth)
A predetermined fixed size: It may differ depending on a frequency or depending on a frequency range.

(2) Resource allocation for other SI transmission: A size of a bandwidth for other SI transmission may be one of the following.
An SS block size or a minimum system bandwidth (when any other configuration is not given)
The same size as a CORESET for scheduling other SI: when there are one or more CORESETs for other SI transmission, a bandwidth for other SI transmission may be a total set bandwidth of the one or more CORESETs. The total set bandwidth may include a PRB which does not belong to the CORESETs but located between the CORESETs.
A size of a bandwidth that is explicitly configured for data transmission
A system bandwidth (when UE knows the system bandwidth)
A predetermined fixed size: It may differ depending on a frequency or depending on a frequency range.
The same size as a potential bandwidth of minimum SI (especially when an SS block is shared between the minimum SI and the other SI)

(3) Resource allocation for a random access response (RAR) in a random access procedure: A size of a bandwidth for RAR transmission may be one of the following.
An SS block size or a minimum system bandwidth (when any other configuration is not given)
The same size as a CORESET for scheduling a RAR: when there are one or more CORESETs for RAR transmission, a bandwidth for RAR transmission may be a total set bandwidth of the one or more CORESETs. The total set bandwidth may include a PRB which does not belong to the CORESETs but located between the CORESETs.
A size of a bandwidth that is explicitly configured for data transmission
A system bandwidth (when UE knows the system bandwidth)
A predetermined fixed size: It may differ depending on a frequency or depending on a frequency range.
The same size as a potential bandwidth of minimum SI (especially when an SS block is shared between the minimum SI and the RAR)
The same size as a potential bandwidth of other SI (especially when an SS block is shared between the other SI and the RAR)

(4) Resource allocation for Msg 3 in a random access procedure: A size of a bandwidth for Msg 3 transmission may be one of the following.
The same size as a physical random access channel (PRACH) resource bandwidth
At least in time division duplex (TDD), the same bandwidth as DL may be used. In frequency division duplex (FDD), a fixed DL-UL gap may be used unless a different configuration regarding the DL-UL gap is given.
A system bandwidth (when UE knows the system bandwidth)
A predetermined fixed size: It may differ depending on a frequency or depending on a frequency range.
A frequency and a bandwidth, which are explicitly configured by a PRACH configuration

(5) Resource allocation for Msg 4 in a random access procedure: A size of a bandwidth for Msg 4 transmission may be one of the following.
An SS block size or a minimum system bandwidth (when any other configuration is not given)
The same size as a CORESET for scheduling Msg 4: when there are one or more CORESETs for Msg 4 transmission, a bandwidth for Msg 4 transmission may be a total set bandwidth of the one or more CORESETs. The total set bandwidth may include a PRB which does not belong to the CORESETs but located between the CORESETs.
A size of a bandwidth that is explicitly configured for data transmission
A system bandwidth (when UE knows the system bandwidth)
A predetermined fixed size: It may differ depending on a frequency or depending on a frequency range.
The same size as a potential bandwidth of minimum SI (especially when an SS block is shared between the minimum SI and Msg 4)
The same size as a potential bandwidth of other SI (especially when an SS block is shared between the other SI and Msg 4)
The same size as a potential bandwidth of RAR (especially when an SS block is shared between the RAR and Msg 4)

(6) Resource allocation for HARQ-ACK of Msg 4 in a random access procedure: A size of a bandwidth for transmitting HARQ-ACK of Msg 4 may be one of the following.
in compliance with a HARQ-ACK resource configuration when a system bandwidth is assumed.
The same size as a bandwidth for Msg 3 transmission
A bandwidth that is explicitly configured through an RAR or PRACH configuration.

(7) Resource allocation for UE-specific data after a random access procedure: A size of a bandwidth for UE-specific data transmission after a random access procedure may be one of the following.
The same size as a bandwidth/frequency of RAR or Msg 4 transmission

The same size as a CORESET for scheduling Msg 4: when there are one or more CORESETs for Msg 4 transmission, a bandwidth for Msg 4 transmission may be a total set bandwidth of the one or more CORESETs. The total set bandwidth may include a PRB which does not belong to the CORESETs but located between the CORESETs.
A size of a bandwidth that is explicitly configured for data transmission
A system bandwidth (when UE knows the system bandwidth)
A predetermined fixed size: It may differ depending on a frequency or depending on a frequency range.

(8) Resource allocation for HARQ-ACK of PDSCH after a random access procedure and before a radio resource control (RRC) configuration: A size of a bandwidth for transmitting a HARQ-ACK of a PDSCH may be one of the following.
In compliance with a HARQ-ACK resource configuration when a system bandwidth is assumed
The same size as a bandwidth for Msg 3 transmission or as a bandwidth for transmission of HARQ-ACK of Msg 4
A bandwidth that is explicitly configured through a RAR or a PRACH.

A UE-specific bandwidth (that is, BWP) may be configured after RRC configuration. When UE is configured with a BWP with respect to DL/UL (for example, in combination with respect to TDD/separately with respect to FDD), the configured BWP may be used for data allocation at least on a USS. Alternatively, a bandwidth different from a data bandwidth may be configured for each search space.

In regard to a non-UE-specific control signal/data, the following may be considered.

(1) A non-UE-specific bandwidth may be based on a system bandwidth, regardless of a BWP.

(2) A non-UE specific bandwidth may be based on an explicitly or implicitly configured bandwidth that may be different from the BWP.

(3) In order to align non-UE specific data bandwidths between UEs, a non-UE specific bandwidth may be identical to the BWP. This may be guaranteed by a network.

In the case of the above (1) and (2), UE may support only the BWP, rather than the non-UE specific bandwidth, and the UE does not need to monitor other than the configured BWP (that is, only a part of data is read). Alternatively, in the case of the above (1) and 20, the UE may increase a bandwidth in order to successfully read data. For example, this is the case when a MBMS or a single cell point-to-multipoint (SC-PTM) is received from a bandwidth that is wider than the BWP (when the UE adjusts a bandwidth to a narrower bandwidth). At this point, a set of subframes in which the non-UE specific data is transmitted may be configured or restricted. A bandwidth may be increased by increasing an RF/baseband bandwidth using a plurality of RFs. Increasing a bandwidth using a plurality of RFs can be applied only to DL.

Hereinafter, fallback DCI and resource allocation bandwidth processing according to the present disclosure will be described. Fallback DCI may refer to DCI that can be stably read by UE in any case. Issues to be possibly raised in regard to the fallback DCI may be as follows.
A size of a BWP may be dynamically changed in response to change of the BWP. Accordingly, a size of a resource allocation field included in DCI may be changed, and a size of the DCI itself may be changed. However, it is not desirable that a size of fallback DCI which should be stably read by the UE is dynamically changed.
When the DCI is transmitted through CSS shared between a plurality of UEs configured with different BWPs, it is a problem as to how to configure the fallback DCI.

In regard to fallback DCI and resource allocation bandwidth processing, the following cases may be considered.

(1) Center frequency change (that is, when a previous BWP and a new BWP do not overlap)

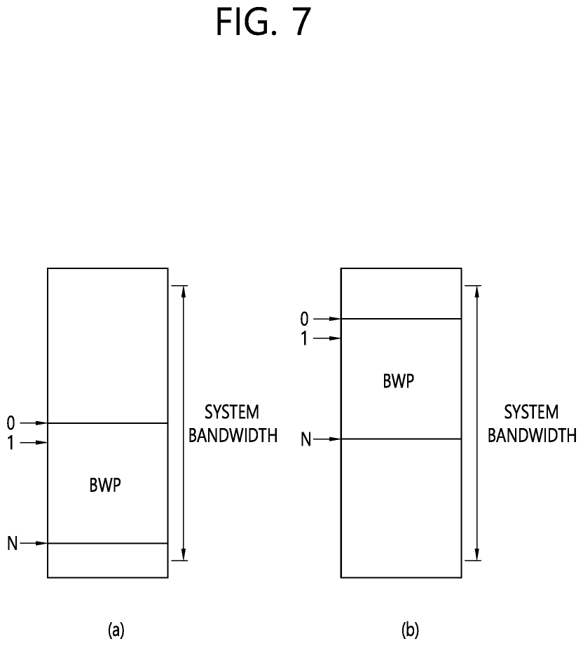

FIG. 7 shows a case where a BWP is changed according to an embodiment of the present disclosure. A previous BWP configured in FIG. 7-(a) does not overlap a new BWP configured in FIG. 7-(b). That is, it is the case where a location of a frequency domain of a BWP and/or a center frequency is changed in response to change of the BWP.

In this case, the UE may be configured with SS block configuration information which includes a center frequency and CSS/USS for each BWP, and which is used in each BWP. Change of a BWP may be triggered by an RRC, a media access control (MAC) control element (CE), or L1 signaling. If the center frequency is changed, the bandwidth itself may be changed as well.

SS block configuration information may include an explicit configuration regarding an SS block and/or CORESET including an aggregation level (AL) for each BWP, a blind decoding (BD) number, etc. The SS block configuration information may be given through a BWP configuration. If an explicit configuration is not given, information used at a previous BWP in regard to the SS block may be maintained intact even when the BWP is changed. For example, if a USS of 10 MHz is configured at one BWP, a USS of the same bandwidth may be configured at a different BWP. In addition, information regarding an AL, a BD number, etc. used at a previous BWP may be maintained intact at a new BWP. In particular when TDD is used, a physical uplink control channel (PUCCH) bandwidth also needs to be reconfigured for a new BWP.

When the BWP is changed, CSS configuration and the like may be indicated by a BWP change indication. If the BWP change indication is transmitted through L1 signaling, a control signal may schedule data and the data may include new configuration information including a frequency location and a bandwidth of a new BWP.

The CSS may be explicitly configured with a bandwidth different from the BWP or may be configured based on a system bandwidth. In order to address ambiguity between UE and a network, the network may transmit a control signal and/or data through both a USS and a CSS during a reconfiguration period. In addition, in order to transmit some non-UE specific control signals/data, the UE may be required to receive the corresponding signals/data at a BWP that may be different from a new BWP.

Configuration information necessary to change a location of a BWP may include at least one of the following.
A center frequency and/or bandwidth of a BWP in DL/UL (separately or in combination of DL/UL): The start PRB or the last PRB of the BWP may also be indicated.
CORESET configuration information for a search space
When a non-UE specific data bandwidth is different from the BWP, different configuration information for the corresponding non-UE specific data bandwidth.
A PUCCH resource used at the BWP
A PRACH resource used at the BWP (with respect to at least a non-contention based PRACH resource triggered by a PDCCH)
A sounding reference signal (SRS) configuration used at the BWP
A channel state information reference signal (CSI-RS) configuration used at the BWP (unless the CSI-RS configuration is given based on a system bandwidth or the CSI-RS configuration is configured separately)
A resource reserved at the BWP (in other cases)
A location of an SS block in the BWP (when such information exists, the information may be signaled in combination with a reserved resource for the purpose of data rate matching in a serving cell.)
A period and/or offset of an SS block for neighboring cell measurement, a frequency location of an SS block of a neighboring/serving cell within a BWP, a measurement bandwidth/frequency: If such information does not exist, the same information used at a previous BWP may be used or a default value may be used.
A bandwidth of data scheduled by fallback DCI: It may be the same as a bandwidth for non-UE specific data such as SIB/RAR or cell common transmission. That is, it may be the same as a bandwidth of an initial BWP. Alternatively, a bandwidth used for fallback DCI may be the same as the smallest bandwidth among BWPs configured for UE. That is, when a BWP is changed and a previous BWP and a new BWP do not overlap, a bandwidth used for fallback DCI may be explicitly configured for each search space.

If a network changes a UL BWP of UE in a carrier which carries a PUCCH, this means that the PUCCH resource needs to be changed as well. Since a PUCCH resource was indicated not based on a mew UL BWP but based on a previous UL BWP, the UE may be not aware of a PUCCH if the UL BWP is changed. Accordingly, regardless of a PUCCH/physical uplink shared channel (PUSCH) piggyback configuration or a PUCCH format configuration (e.g., a short PUCCH, time division multiplexing (TDM) with a PUSCH), if a UL BWP is changed in a carrier carrying the PUCCH, a HARQ-ACK and uplink control information (UCI) transmitted through the PUCCH may be piggyback through a PUSCH in a new BWP. In addition, after the UL BWP is changed, if a HARQ-ACK resource indicates a previous BWP (that is, if DL scheduling DCI is transmitted before an UL BWP change indication) and if the HARQ-ACK cannot be piggyback through the PUSCH, the transmission may be omitted. A UL BWP change timing may be a slot at which PUSCH transmission is triggered by DL scheduling DCI along with the UL BWP change indication. After the UL BWP change indication is received, all HARQ-ACK resources in the DL scheduling DCI indicate a HARQ-ACK resource in the new UL BWP. For example, it is assumed that DL scheduling DCI is transmitted in slot n, that a HARQ-ACK regarding the DL scheduling DCI is scheduled in slot n+5, that a UL grant indicating BWP change in slot n+5 is transmitted in slot n+1, that DL transmission is performed in slot n+2, and that a HARQ-ACK regarding the DL transmission is scheduled in slot n+6. At this point, in slot n+5, a HARQ-ACK is piggyback through a PUSCH and transmitted. In slot n+6, a HARQ is transmitted through a new HARQ-ACK resource in the new BWP. Considering the case where the network misses a HARQ-ACK, the network may blindly search for two potential resources for HARQ-ACK or UCI detection.

(2) Frequency band change (that is, when a previous BWP and a new BWP partially or fully overlap)

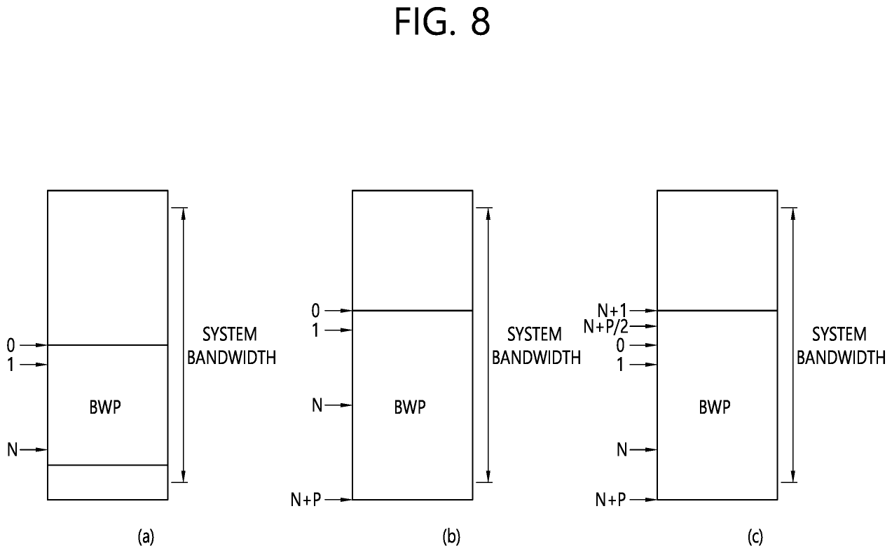

FIG. 8 shows a case where a BWP is changed according to another embodiment of the present disclosure. A previous BWP configured in FIG. 8-(a) and a new BWP configured in FIG. 8-(b) or FIG. 8-(c) partially or fully overlap. It is the case where a size of a frequency band, rather than a center frequency, is changed in response to change of a BWP.

Even when a size of a frequency band is changed in response to change of a BWP, the same mechanism used when a center frequency is changed may be used. That is, the description of the present disclosure regarding “(1) Center frequency change (that is, when a previous BWP and a new BWP do not overlap)” may be applied even to “(2) Frequency range change (that is, when a previous BWP and a new BWP partially or fully overlap)”. However, in order to prevent unnecessary duplication or RRC ambiguity, the following additional optimization may be considered for various cases.
Case 1: When a new BWP is greater than a previous BWP and the new BWP fully encompasses the previous BWP or when a new BWP is smaller than a previous BWP and the new BWP is fully included in the previous BWP

In this case, the least overlapping BWP among configured BWPs may be used as a bandwidth for fallback DCI. For example, if a previous BWP is 5 MHz and a new BWP is 20 MHz, 5 MHz may be used as bandwidth for fallback DCI. That is, regardless of BWP change, the fallback DCI may be transmitted at 5 MHz. In more general, bandwidth and frequency locations for fallback DCI may be implicitly configured or determined.
Case 2: When a new BWP is greater than a previous BWP and the new BWP includes a part of the previous BWP or when a new BWP is smaller than a previous BWP and a part of the new BWP is included in the previous BWP.

In this case, when fallback DCI is included in a new BWP, a bandwidth used for the fallback DCI may comply with a fallback DCI bandwidth configuration. Otherwise, a new configuration from a new BWP may be used. Alternatively, if a new configuration regarding the fallback DCI, the new configuration may be used. Otherwise, a bandwidth used for the fallback DCI previously may be used.

In order to prevent ambiguity in a USS, a bandwidth resource index of fallback DCI may not be changed regardless of a bandwidth. An additional resource required in response to change of the BWP may be indexed outside a bandwidth for the fallback DCI or a minimum bandwidth.

Referring to FIG. 8-(a), previous BWPs before BWP change may be indexed from 0 to N. Referring to FIG. 8-(b), bandwidths of a new BWP are increased as compared with a previous BWP in response to BWP change, and accordingly, resources of the new BWP are newly indexed from 0 to N+P. That is, if resources are indexed as shown in FIG. 8-(b), an index of each resource of the new BWP is different from an index of each resource of the previous BWP. Meanwhile, referring to FIG. 8-(c), bandwidths of a new BWP are increased as compared with a previous BWP in response to BWP change, and the bandwidths of the new BWP are the same as those of the new BWP shown in FIG. 8-(b). However, resources indexed from 0 to N in the existing BWP remain being indexed from 0 to N in the new BWP, and newly added resources are newly indexed from N+1 to N+P.

In addition, necessary parameters such as a numerology, a CORESET for scheduling, etc., may be configured in the same manner of a data bandwidth.

Alternatively, a BWP may be changed if explicit confirmation from a network or a timer-based confirmation is performed. That is, if reconfiguration is regarded complete, the UE may apply a new configuration. Until then, the UE may apply a previous configuration.

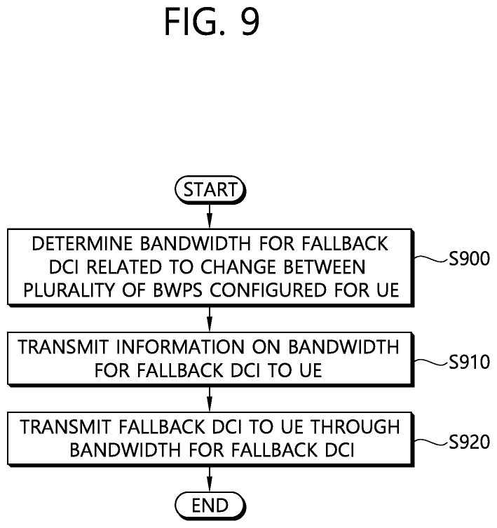

FIG. 9 shows a method for transmitting fallback DCI by a base station according to an embodiment of the present disclosure. The above description of the present disclosure regarding fallback DCI may be applied to the present embodiment.

In step S900, a base station determines a bandwidth for the fallback DCI related to change between a plurality of BWPs configured for a UE. A pre-change BWP and a post-change BWP may not overlap due to the change between the plurality of BWPs. A bandwidth for data scheduled by the fallback DCI may be the same as a bandwidth used for cell common data. The bandwidth for the fallback DCI may be the same as the smallest BWP among the plurality of BWPs. Alternatively, a pre-change BWP and a post-change BWP may overlap due to the change between the plurality of BWPs. At this point, a bandwidth for the fallback DCI may correspond to a bandwidth overlapping between the previous BWP and the new BWP.

In step S910, the base station transmits information on the bandwidth for the fallback DCI to the UE. The information on the bandwidth for the fallback DCI may be transmitted through a configuration message that indicates change between the plurality of BWPs. The configuration message may further include information on a PRACH resource used in the plurality of BWPs.

In step S920, the base station transmits the fallback DCI to the UE through the bandwidth for the fallback DCI.

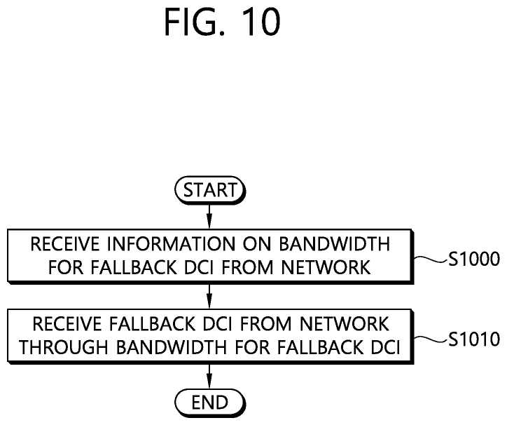

FIG. 10 shows a method for receiving fallback DCI by a UE according to an embodiment of the present disclosure. The above description of the present disclosure regarding fallback DCI may be applied to the present embodiment.

In step S1000, a UE receives information on a bandwidth for the fallback DCI from a network. In step S1010, the UE receives the fallback DCI from the network through the bandwidth for the fallback DCI. The bandwidth for the fallback DCI may be determined regardless of sizes and locations of BWPs configured for the UE.

The bandwidth for the fallback DCI may correspond to a part overlapping between the plurality of BWPs configured by the network. The bandwidth for data scheduled by the fallback DCI may be the same as a bandwidth to be used for cell common data. Information on the bandwidth for the fallback DCI may be received through a configuration message that indicates change between the plurality of BWPs. The configuration message may include information regarding a PRACH resource used in the plurality of BWPs.

3. PRB Indexing/Scrambling

PRB indexing/scrambling in accordance with each control signal/data may be as follows.

(1) Cell common or UE group common control signal/data
PRB indexing/scrambling in a BWP configured for data transmission
PRB indexing/scrambling in a BWP configured for a CORESET for a control signal and in a BWP configured for data transmission for data
PRB indexing/scrambling in a system bandwidth or a maximum bandwidth (e.g., a virtual PRB based on common PRB indexing)
PRB indexing/scrambling in a BWP configured to be identical or not identical to a data bandwidth (e.g., a bandwidth for subband)
PRB indexing/scrambling based on a system bandwidth or a BWP (e.g., a carrier bandwidth or a maximum bandwidth) for a control signal/data.

(2) UE-Specific Control Signal/Data
PRB indexing/scrambling in a USS including at least a dedicated reference signal and in a BWP configured for UE-specific data
PRB indexing/scrambling based on a system bandwidth or a BWP (e.g., a carrier bandwidth or a maximum bandwidth) for a control signal including a shared reference signal, and PRB indexing/scrambling based on a configured BWP for the rest other than the control signal

(3) Dedicated reference signal: PRB indexing/scrambling may be performed based on a BWP or an allocated PRB. In the case of discontinuous resource allocation, scrambling or sequence generation may be performed based on a bandwidth between the first PRB and the last PRB of resource allocation. Alternatively, scrambling or sequence generation may be performed based on common PRB indexing on a BWP or on a maximum system bandwidth.

(4) Shared reference signal: PRB indexing/scrambling may be performed based on a system bandwidth, a CORESET or BWP that uses or a shared reference signal. Alternatively, scrambling or sequence generation may be performed based on common PRB indexing on a BWP or a maximum system bandwidth.

(5) Other reference signal: PRB indexing/scrambling may be performed based on a system bandwidth or a CORESET or BWP that uses a shared reference signal. Alternatively, scrambling or sequence generation may be performed based on common PRB indexing on a BWP or a maximum system bandwidth.

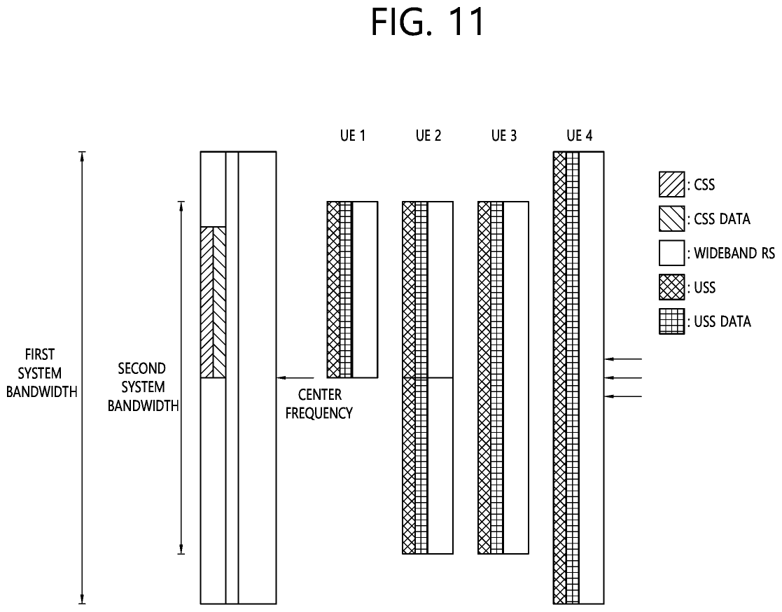

FIG. 11 shows an example in which different UEs are configured with different bandwidths in a carrier according to an embodiment of the present disclosure. Referring to FIG. 11, USSs and USSs for data may be configured differently for UE1 to UE4.

For the future flexibility and potential extension, indexing a sequence of a control signal/data/reference signal from a center frequency to a maximum bandwidth or a maximum PRB index may be considered. The maximum PRB index may be predetermined or may be indicated by PBCH/SIB. When the maximum PRB index is considered, a PRB index near the center frequency may be near max_PRB/2. Otherwise, it may be difficult for UEs having different bandwidth to share the same resource for a control signal/data/reference signal. Alternatively, common scrambling/PRB indexing may be used for at least a shared control signal/data/reference signal, and local scrambling/PRB indexing may be used for UE-specific shared control signal/data/reference signal.

4. DCI Processing

Since a bandwidth for a UE may differ depending on a configuration, a size of a resource allocated to the UE may differ. Accordingly, a size of DCI which allocates the resource may differ. Thus, a mechanism which fixes a size of e DCI regardless of a bandwidth may be needed. For DCI in a fixe size, the following may be considered depending on a type of the DCI.

(1) DCI for cell common data (e.g., DCI including system information radio network temporary identifier (SI-RNTI), random access RNTI (RA-RNI), paging RNTI (P-RNTI), etc.)

When a plurality of RNTIs share the same search space, it may be desirable to fit to the same size of DCI. Accordingly, a size of DCI for cell common control signal/data transmission may be signaled through a PBCH included in an SS block, minimum SI, or other SI. Given that the minimum SI can be read after RRC connection, it is desirable that the size of the DCI for cell common control signal/data transmission is signaled through a PBCH included in an SS block. Alternatively, the size of the DCI for cell common control signal/data transmission may be predetermined. The size of the DCI for cell common control signal/data transmission may be derived from a configuration of a CORESET for a control signal that is used to schedule the minimum SI. For example, when a resource block group (RBG) in a specific size is assumed, a bandwidth of the minimum SI may be used to determine the size of the DCI for cell common control signal/data transmission. Even a size of the RBG may be also defined by the bandwidth of the minimum SI. It may be assumed that if there are two RBG sets, the first RBG set is selected, unless explicitly configured otherwise.

(2) DCI for Group Common Data

In order to reduce BD overhead, a size of DCI for group common data may also be indicated by a PBCH or may be configured as a fixed value unless the group common data and cell common data are scheduled in different subframe sets. The size of the DCI for the group common data may be derived based on a configuration of a CORESET for a control signal that schedules minimum SI. For example, when an RBG in a specific size is presumed, a bandwidth of the minimum SI may be used to determine the size of the DCI for the group common data. Even the size of the RBG may be defined by the bandwidth of the minimum SI.

(3) DCI for UE-Specific Data Scheduled in CCI

A size of DCI for UE-specific data scheduled in a CSS may be configured semi-persistently.

(4) DCI for UE-Specific Data Scheduled in USS

A size or UE-specific data scheduled in a USS and/or a set of fields included in the DCI may be configured semi-persistently. DCI in different sizes may be used for different BWPs. In addition, DCI in different sizes may be used for different transmission modes (TMs).

In more general, a size of DCI used for a specific CORESET may be configured explicitly. Alternatively, a size of a RBG or PRB may be defined for each CORESET, along with an REG bundling and/or REG bundling size. If these configurations do not exist, a size of DCI for at least UE-specific data scheduled in a USS may be determined by a BWP. In other cases, a determination as to a bandwidth for the aforementioned data may be used to determine a size of DCI.

For simpler design, a CORESET and a search space may be defined as follows.

(1) Initial CSS: An initial CSS may be used to read minimum SI, other SI, RAR, Msg 4, RRC configuration, etc. A bandwidth of data scheduled by the initial CSS may be regarded as a minimum UE bandwidth (e.g., 20 MHz). Even in a case where the bandwidth is adapted, a minimum bandwidth which a UE can access may be restricted by the minimum UE bandwidth. Thus, even when a bandwidth is reduced, the UE is capable of reading cell common control signal/data. If the bandwidth of the UE is reduced beyond the minimum UE bandwidth, the UE may temporarily increase the bandwidth in order to read at least the CSS and/or the cell common control signal/data. Meanwhile, the initial CSS may be accessed by an initial access procedure, without help from a PCell or a different subcarrier.

(2) CSS: A CSS may be used to read a cell common control signal/data after an initial access procedure. The CSS may be identical to an initial CSS or may be configured different from the initial CSS. A bandwidth of data scheduled by a CSS may be explicitly configured or may be implicitly defined as a BWP or may be fixed. Alternatively, a size of DCI for data scheduled by a CSS may be explicitly configured. UEs sharing the same CSS are capable of reading the corresponding CSS, regardless of bandwidth adaptation. In order to support this feature, different CSS may be configured based on different BWP configurations. Meanwhile, UE-specific data may be scheduled by a CSS as well. A size of DCI for the UE-specific data may be identical to a size of DCI for scheduling cell common data.

(3) USS: A USS may be used to read a UE-specific control signal/data. A bandwidth of data scheduled by a USS may be defined as a BWP. A total size of DCI for data scheduled by the USS may be defined based on contents contained in the DCI, a configured TM, and a bandwidth. When a fallback TM is supported, a size of DCI for the fallback TM may be determined based on basic DCI content (e.g., code block group (CBG) retransmission is not configured), a fallback TM, a bandwidth identical to that of fallback DCI that can be scheduled by a CSS. When a size of fallback DCI is maintained the same in a USS regardless of bandwidth adaptation, there is an advantage to receive L1 signaling through the USS by using the same size of the fallback DCI.

For different DCI contents and/or sizes for data scheduled by a USS, a plurality of DCI sets having different DCI contents and/or sizes may be configured and one DCI set among them may be selected by MAC CE or L1 signaling. This may be realized by dynamic bandwidth adaptation.

Due to dynamic bandwidth adaptation or UL grant size adaptation, DL/UL bandwidths may differ. Accordingly, DL assignment and UL grant size may differ. In addition, a gap between DL assignment and a UL grant may increase depending on a content contained in the DCI. In order to address this issue, it is possible to at least match a size of fallback DCI and a size of the UL grant, and, to this end, padding necessary for the fallback DCI or the UL grant may be used. Further, the DL assignment and the UL grant may use different sizes, and the fallback DCI may not be transmitted through a USS.

A size of PRB bundling and/or PRG/RBG size may be configured for a UE through higher layer signaling. More specifically, the PRB size bundling (and subband size for CSI feedback) may be configured as one of the following.
Independent parameter dividable by RBG size or multiple RBG sizes (that is, RBG size=k*PRB bundling size or subband size)
Size identical to RBG size
Dynamic indication between the above two options.

Specifically, a size of DCI for an initial access procedure, cell common control signal/data, group common control signal/data, and UE-specific control signal/data may be determined according to Table 1.

TABLE 1

| | | | | | USS - DL | USS - UL | USS - | USS - |
|---|---|---|---|---|---|---|---|---|
| | Initial | | CSS - DL | CSS - UL | Fallback | Fallback | DL TM | UL TM |
| | CSS | CSS | Scheduling | Scheduling | TM | TM | Scheduling | Scheduling |
| | (DCI1) | (DCI2) | (DCI3) | (DCI4) | (DCI5) | (DCI6) | (DCI7) | (DCI8) |
| MCS | <=M bit | <=M bit | M bit | M bit | M bit | M bit | M * | M * |
| | | | | | | | Number of | Number of |
| | | | | | | | Code words | Code words |
| Resource | Based on | Based on | Based on | Based on | Based on | Based on | Based on | Based on |
| allocation | system | configure | the smallest | the smallest | the smallest | the smallest | UL BWP | UL BWP |
| | bandwidth or | bandwidth | DL BWP or | UL BWP or | DL BWP or | UL BWP or | | |
| | minimum | | configured | configured | DL BWP | UL BWP | | |
| | value in | | bandwidth | bandwidth | | | | |
| | UE minimum | | | | | | | |
| | bandwidth | | | | | | | |
| NDI | 1 | 1 | 1 | 1 | 1 | 1 | 1 | 1 |
| HARQ process ID | K1 | K1 | K2 | K3 | K2 | K3 | K2 | K3 |
| RV | N | N | N | N | N | N | N | N |
| TPC | N/A | N/A | P bit | P bit | P bit | P bit | P bit | P bit |
| Start location of | Q1 | Q1 | Q1 or Q2 | Q1 or Q3 | Q1 or Q2 | Q1 or Q3 | Q2 | Q3 |
| PDSCH/PUSCH | | | | | | | | |
| PDSCH/PUSCH interval | R1 | R1 | R1 or R2 | R1 or R3 | R1 or R2 | R1 or R3 | R2 | R3 |
| HARQ-ACK resource | N/A | N/A | S | N/A | S | N/A | S | N/A |
| Beam direction for | N/A | N/A | 0 or X | 0 or X | 0 or X | 0 or X | X | X |
| PDSCH/PUSCH | | | | | | | | |
| Flag for TB based or | N/A | N/A | 0 or 1 | N/A | 0 or 1 | N/A | 1 | N/A |
| CBG based HARQ-ACK | | | | | | | | |
| CBG bitmap for | N/A | N/A | 0 or Y | N/A | 0 or Y | N/A | Y * | N/A |
| retransmission | | | | | | | Number | |
| | | | | | | | of Code | |
| | | | | | | | words | |
| Number of Subbands | N/A | N/A | 0 | 0 | 0 | 0 | | Z |
| for UL grant and | | | | | | | | |
| Subband PMI | | | | | | | | |

In Table 1, in order to match DCI1 size and DCI2 size, the following may be considered. Sizes of resource allocation fields may be matched, or DCI1 size and DCI2 size may be determined to a fixed value, regardless of a minimum UE bandwidth.
If a bandwidth configured for DCI2 is smaller than a bandwidth configured for DCI1 (that is, if they are not identical), different RBG sizes may be applied. This is a method for matching the sizes of DCI1 size and DCI2 by adjusting the RBG size.

In Table 1, the following may be considered in order to match DCI2 size and DCI3 size.
Bandwidths of DCI2 and DCI3 may be matched. Accordingly, a field in DCI3 may exist in DCI2, and the corresponding field may be filled with 0 in DCI2. Alternatively, DCI2 size and DCI3 size may be defined to add padding necessary for DCI2, and DCI3 size may be adjusted according to a configured DCI size. If necessary, DCI3 size may become matching the configured DCI size by adding padding necessary for DCI3. In order to prevent complexity of DCI design, a sufficiently great DCI size may be configured so as to include both DCI2 and DCI3 for a UE sharing DCI2.
If a bandwidth for DCI3 is smaller than a bandwidth for DCI2, most of fields existing only in DCI3 may be assumed to be 0.
With DCI2 and DCI3 having the same size but different contents, a UE may assume different DCI contents based on an RNTI.

In Table 1, the following may be considered to match DCI3 size and DCI4 size.
If it is not necessary to match DCI2 size and DCI3 size, DCI3 size and DCI4 size may be matched by selecting a greater one from DCI3 size and the DCI4 size and adding a bit field to differentiate DCI3 and DCI4.
When it is not necessary to match DCI2 and DCI3, DCI2 size may be considered as DCI4 size. For the matching, padding may be necessary for each DCI.

DCI5/6 size or DCI7/8 size may be matched according to the above description. However, DCI5/6 size or DCI7/8 size are scheduled in different search spaces and therefore not needed to be matched as do DCI1 to DCI4.

5. Localized Resource Mapping and Distributed Resource Mapping

(1) Localized Resource Mapping

In NR, different UEs may access different bandwidths in a given specific time. When localized resource mapping is used, matching RBGs between different bandwidths may be advantageous. In order to match RBGs between different bandwidths, the following may be considered.
RBG size may be configured for each UE. However, RBG size may be a multiple of a minimum RBG size. The minimum RBG size may be, for example, 2 PRB. In terms of UE bandwidth configuration, a bandwidth may be a multiple of a minimum and/or configured RBG size as well.
A RBG size may be configured based on a system bandwidth. A UE may apply a RBG size based on a system bandwidth, regardless of a bandwidth configured for the UE. As for a single RBG shared between different UEs, a partial PRG is scheduled for different UEs and thus different precoding may be applied even for a single RBG.

(2) Distributed Resource Mapping

When distributed resource mapping is used, at least one of the following may be considered for efficient multiplexing between a plurality of UEs using distributed resource mapping.
Distributed resource mapping may be used only in a subband. Each UE may be comprised of one or more subbands. As distributed resource mapping is used only in a subband, multiplexing between UEs having different bandwidths may be processed efficiently. A subband size may be determined based on a system bandwidth and/or a frequency domain or may be configured by a higher layer.
In consideration of multiplexing between localized resource mapping and distributed resource mapping, the distributed resource mapping may take into account interleaving not in RB level but in RBG level. That is, if distributed resource mapping is applied, each RBG may be regarded as a single bundling unit for interleaving. For example, if an RBG size is 4 PRB and a total bandwidth is 200 PRB, 50 bundling units in total may be distributed based on an interleaving function. In each RBG, additional interleaving may be applied or may not be applied. According to this method, efficient multiplexing between localized resource mapping and distributed resource mapping may be performed in RBG level. A size of a bundling unit may be configured by a cell-specific or UE-specific configuration.
A bandwidth of distributed resource mapping may be configured in a place where interleaving is applied. Different frequency locations may be used for localized resource mapping and distributed resource mapping. If a UE bandwidth is smaller than a bandwidth configured for distributed resource mapping, a UE may receive data only in the UE bandwidth and may ignore a resource allocated outside the UE bandwidth. An example of bandwidth configuration, distributed resource mapping may be performed across a system bandwidth. Alternatively, for distributed resource mapping, a bandwidth smaller than the system bandwidth may be configured, and, at this point, interleaving may occur many times in different frequency domains. This case may be used when a network multiplexes a narrow-band UE and a broadband UE in the same frequency.

Distributed resource mapping is advantageous when compact resource allocation (e.g., continuous resource allocation) is used. Thus, a bandwidth where distributed resource mapping is applied may correspond to at least one of the following. In the case where a plurality of options is considered, such a bandwidth may be configured by a network.
Unless indicated otherwise, a UE may assume that distributed resource mapping is performed in a configured UE bandwidth (e.g., BWP) or a data bandwidth.
Unless indicated otherwise, a UE may assume that distributed resource mapping is performed in a system bandwidth.
A UE may assume that distributed resource mapping is performed in a configured UE bandwidth. The configured UE bandwidth may be identical to or different from a data bandwidth.
A UE may assume that distributed resource mapping is performed in a subband. A subband size may be configured.

(3) Interleaving Function

When distributed resource mapping is used, at least one of the following may be considered in regard to an interleaving function, especially block interleaving.
For randomization, a single block interleaver may be determined to be N*32. N may be ceil (M/32), and M may be a total number of bundling units. If a bundling unit size is 1 RB, M may be the number of RBs in a bandwidth for distributed resource mapping. If the bundling unit size is K RB, M may be the number of bundling units in a bandwidth for distributed resource mapping.
For randomization in a subband, different block interleavers may be used in a subband.
For uniform distribution, a size of one block interleaver may be determined to be P*K. K may be an RB for uniform distribution. If uniform distribution occurs in 3 RB, K may be 3. P*K may be greater than or equal to the number of bundling units in a bandwidth for distributed resource mapping.
For randomization, a randomization function such as PUCCH 2 in 3GPP LTE may be used.
For a more decisive pattern, an offset-based hopping pattern may be considered. Each RB or RBG or bundling unit may hop within a plurality offset RBs or bundling units.

In a case where distributed resource mapping or interleaving is performed in a configured UE-specific bandwidth or a bandwidth wider than a BWP, it is necessary to clearly define whether a resource is still allocated in the BWP nonetheless or allocated in a bandwidth where interleaving is performed. If distributed resource mapping is performed in a bandwidth wider than a BWP, a resource may be allocated in the bandwidth where interleaving is performed and a UE may ignore a PRB outside the BWP. That is, PRB indexing for distributed resource mapping may be performed in the bandwidth where interleaving is performed. When a plurality of interleaving blocks is configured for a UE, PRB indexing may increase across interleaving blocks. Alternatively, two steps of resource allocation may be performed. That is, the first step is a step of indicating which interleaving block is scheduled, and the second step is a step of indicating a PRB in the scheduled interleaving block.

Meanwhile, the above-described present disclosure may be applied even in UL. In particular, distributed resource mapping may be used in UL only when an OFDM-based waveform is used for UL transmission. In addition, when frequency hopping is used, the same technology may be applied to UL that applies discrete Fourier transform spread OFDM (DFT-s-OFDM). The frequency hopping may be performed in configured BWP, in a subband, or across a system bandwidth.

6. RBG Configuration

In general, it is desirable to align RBGs between different UEs. Each UE may not know the entire system bandwidth, and thus, RBG configuration from a reference point may be needed. RBG configuration may be performed according to any one of the following methods.

(1) An RBG may be configured from the center of a subcarrier. Regardless of a system bandwidth, a UE may become to know a boundary of the RBG by knowing a gap or offset between the center of a BWP and the center of the carrier is known.

(2) An RBG may be configured from the center of a BWP. Alternatively, the RBG may be configured from the center of an SS block. At this point, an offset for the RBG may be configured based on the greatest RBG supported in a carrier. The offset may have multiple values according to a numerology supported. The offset may be configured differently according to a numerology.

(3) An RBG may be configured based on common PRB indexing. Further, an offset from a start point of RBG configuration may be configured. If the offset is not configured, the RBG configuration may start from PRB 0. If an UE is not aware of the common PRB indexing, the RBG may be configured based on a BWP (e.g., an initial DL BWP).

For simpler RBG configuration, the center for the RBG configuration may be indicated. An RBG may be configured from the center toward the boundary of a system bandwidth.

In order to determine an RBG size, the following may be considered.

(1) Size of an RBG for RMSI CORESET: Unless indicated otherwise, the size may be fixed to 2 PRB. Alternatively, according to a CORESET bandwidth, the size may be determined to be any one of 2/3/6 PRB. The RBG may be configured in an initial DL BWP.

(2) Size of an RBG for RMSI PDSCH: The size may be fixed to 2 PRB. Alternatively, the size may be fixed to any one of 4/8 PRB according to a PDSCH bandwidth. Other values may be considered as well. That is, the RBG size may depend on a bandwidth. The RBG may be configured in an initial DL BWP. Or, the size of the RBG may be identical to a size of an allocated resource.

In order to indicate an RBG pattern, a transmission diversity, etc., among two parameter sets, indicating 1 or 0 may be considered. The two parameter sets may be pre-configured and may be different depending on a frequency domain.

(3) Size of an RBG for a different CSS PDSCH: The size may be indicated by SI or may be identical to a size of an RBG for RMSI PDSCH. Or, the size may be identical to a size of an allocated resource. Or, the size may be determined depending on a frequency domain or may be determined based on a bandwidth that can be allocated to a PDSCH.

(4) Size of an RBG for a different CSS CORESET: The size may be indicated by SI or may be identical to a size of an RBG for RMSI PDSCH.

(5) Size of an RBG for unicast data: The size may be configured by a network or may comply with a basic RBG size. Or, the size may comply with a RBG size that is used for Msg 4 (in the case of DL) or Msg 3 (in the case of UL).

(6) Size of an RBG for Msg 3: The size may be indicated by SI or may be identical to a size of an RBG for RMSI. Or, the size may be determined based on a Msg 3 bandwidth. Or, the size may be fixed for a frequency domain.

If a center frequency is indicated by RMSI or other SI, RBG configuration may be performed in a localized manner by RMSI and/or other SI. Accordingly, an RBG for RMSI and an RBG for other transmission may not be aligned. Alignment between the RBG for RMSI and the RBG for other transmission may be solved by allocating an appropriate RB gap. That is, RBG processing is similar to processing an RB grid of a greater subcarrier gap.

RBG configuration may be associated with RB indexing. RBB indexing may be divided into common RB indexing and BWP-specific RB indexing (local RB indexing).

(1) Common RB indexing: A single reference point may be defined or configured for common RB indexing. For example, PRB 0 may be used as a reference point for common RB indexing. A plurality of BWPs may overlap in a frequency domain, and therefore some CORESETs may be shared by the plurality of BWPs. At this point, there is an advantage that the common RB indexing can reduce the number of CORESET configurations. On the other hand, BWP-specific RB indexing requires more CORESET configurations and BWP conversion/reconfiguration require a new CORESET configuration, and therefore, even more CORESET reconfiguration are needed. However, since the common RB indexing has a more number of RBs to be indexed, a size of a resource allocation field in DCI may be increased.

(2) BWP-specific RB indexing: A base station may transmit CORESET with respect to each BWP, and a new CORESET configuration may be indicated when BWP reconfiguration is performed. The number of CORESET configurations may increase by BWP-specific RB indexing, but the size of a resource allocation field in each DCI may be maintained small. In addition, there is an advantage in that it is not necessary to discuss various issues possibly occurring in common RB indexing, for example, CORESET sharing mechanism between a plurality of BWPs, configuration of a search space on each BWP, etc.

Both common RB indexing and BWP-specific RB indexing may be used. If BWP-specific RB indexing is used in a BWP, it is necessary to clearly determine how to configure 6 PRB for CORESET configuration. Since the BWP may not start in alignment with 6 PRB in a network carrier, it may be desirable to configure 6 PRB for CORESET based on common RB indexing in order to align CORESETs of different UEs having different BWPs. Or, 6 PRB for CORESET configuration may be configured based on an offset from which a grid of 6 PRB starts.

In addition, an RBG size and a subband size may be determined based on a BWP size. At this point, a network may select which mapping table is used. Since a subband may be used as a channel measurement unit, it is desirable that the boundary of an RBG is at least in alignment with the boundary of the subband. At this point, a range of a BWP size used in a subband size table may be reused as an RBG size table. In addition, the RBG size may be determined by taking into account a subband size. More specifically, as for a given BWP size, a selected subband size may be a multiple of the selected RBG size. In addition, in consideration of compact DCI design for ultra-reliable and low latency communication (URLLC), a mapping table including an even greater RBG size may be considered. Table 2 is a mapping table showing an example of an RBG size across a plurality of BWP sizes.

TABLE 2

| BWP size (PRBs) | Configuration 1 | Configuration 2 |
|---|---|---|
| 20-60 | 2 | 4 |
| 61-100 | 4 | 8 |
| 101-200 | 8 | 8 or 16 |
| 201-275 | 16 | 16 or 32 |

It is necessary to clearly define whether to apply an RBG from PRB 0 of BWP-specific RB indexing in its own BWP or whether to apply an RBG from PRB 0 of common RB indexing. In general, it may be desirable that RBGs are aligned from PRB 0 of common RB indexing. Accordingly, regardless of BWP configuration, RBGs may be aligned between different UEs. At this point, the number of RBGs may be ceil (configured BWP bandwidth/RBG size)+x. X may be one of 0, ′1, and 2 based on a start PRB index of a BWP in common RB indexing.

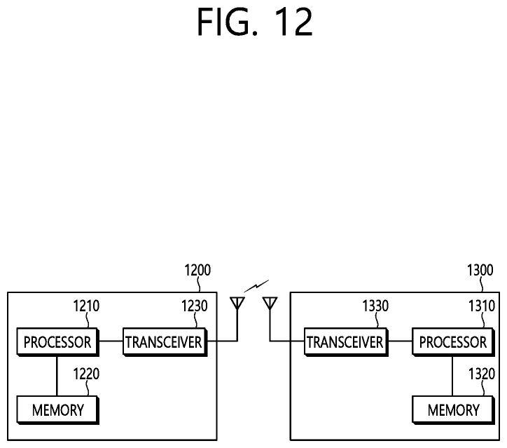

FIG. 12 shows a wireless communication system in which an embodiment of the present disclosure is implemented.

A UE 1200 includes a processor 1210, a memory 1220, and a transceiver 1230. The memory 1220 is connected to the processor 1210 and stores a variety of information required to operate the processor 1210. The transceiver 1230 may be connected to the processor 1210 to transmit a radio signal to a network node 1300 or receive a radio signal from the network node 1300. The processor 1210 may be configured to implement proposed functions, procedures and/or methods described in the present disclosure. More specifically, the processor 1210 may perform steps S1000 and S1010 in FIG. 10 or may control the transceiver 1230 to perform steps S1000 and S1010 in FIG. 10.

The network node 1300 includes a processor 1210, a memory 1220, and a transceiver 1330. The memory 1320 is connected to the processor 1310 and stores a variety of information required to operate the processor 1310. The transceiver 1330 may be connected to the processor 1310 to transmit a radio signal to the UE 1200 or receive a radio signal from the UE 1200. The processor 1310 may be configured to implement proposed functions, procedures and/or methods described in this description. More specifically, the processor 1310 may perform steps S900 to S920 in FIG. 9 or may control the transceiver 1330 to perform steps S900 to S920 in FIG. 9.

The processors 1210 and 1310 may include application-specific integrated circuit (ASIC), other chipset, logic circuit and/or data processing device. The memories 1220 and 1320 may include read-only memory (ROM), random access memory (RAM), flash memory, memory card, storage medium and/or other storage device. The transceivers 1220 and 1320 may include baseband circuitry to process radio frequency signals. When the embodiments are implemented in software, the techniques described herein can be implemented with modules (e.g., procedures, functions, and so on) that perform the functions described herein. The modules may be stored in memories 1220 and 1320 and executed by processors 1210 and 1310. The memories 1220 and 1320 may be implemented within the processors 1210 and 1310 or external to the processors 1210 and 1310 in which case those can be communicatively coupled to the processors 1210 and 1310 via various means as is known in the art.

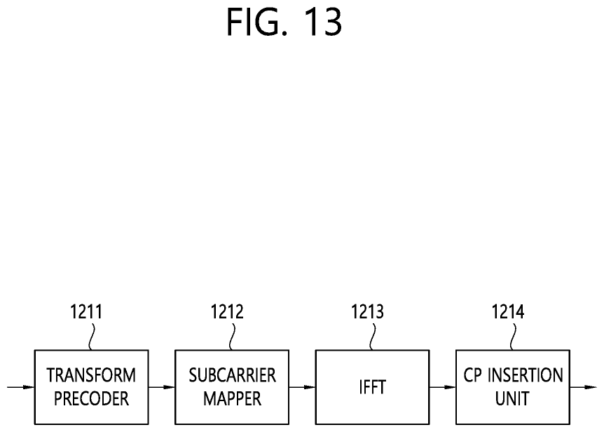

FIG. 13 shows a processor of a UE shown in FIG. 12. The processor 1210 of the UE may include a transform precoder 1211, a subcarrier mapper 1212, an inverse fast Fourier transform (IFFT) unit 1213, and a cyclic prefix (CP) insertion unit (1214).

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

1. A method for transmitting a fallback downlink control information (DCI) by a base station in a wireless communication system, the method comprising:
determining a bandwidth for the fallback DCI related to a change between a plurality of bandwidth parts (BWPs) configured for a user equipment (UE);
transmitting information on the bandwidth for the DCI to the UE; and
transmitting the fallback DCI to the UE through the bandwidth for the fallback DCI.

2. The method of claim 1, wherein a pre-change BWP and a post-change BWP do not overlap each other due to the change between the plurality of BWPs.

3. The method of claim 2, wherein a bandwidth for data scheduled by the fallback DCI is identical to a bandwidth used for cell common data.

4. The method of claim 2, wherein the bandwidth for the fallback DCI is identical to a smallest BWP among the plurality of BWPs.

5. The method of claim 1, wherein a pre-change BWP and a post-change BWP overlap each other due to change between the plurality of BWPs.

6. The method of claim 5, wherein the bandwidth for the fallback DCI correspond to a bandwidth in which the pre-change BWP and the post-change BWP overlap each other.

7. The method of claim 1, wherein the information on the fallback DCI is transmitted through a configuration message indicating the change between the plurality of BWPs.

8. The method of claim 7, wherein the configuration message includes information on a physical random access channel (PRACH) resource used in the plurality of BWPs.

9. A method for receiving fallback downlink control information (DCI) by a user equipment (UE) in a wireless communication system, the method comprising:
receiving information on a bandwidth for the fallback DCI from a network; and
receiving the fallback DCI from the network through the bandwidth for the fallback DCI,
wherein the bandwidth for the DCI is determined regardless of sizes and locations of a bandwidth parts (BWPs) of the UE.

10. The method of claim 9, wherein the bandwidth for the fallback DCI corresponds to a portion in which a plurality of BWPs configured by the network overlaps each other.

11. The method of claim 9, wherein a bandwidth for data scheduled by the fallback DCI is identical to a bandwidth used for cell common data.

12. The method of claim 9, wherein the information on the bandwidth for the fallback is received through a configuration message indicating a change between the plurality of BWPs.

13. The method of claim 12, wherein the configuration message includes information on a physical random access channel (PRACH) resource used in the plurality of BWPs.

14. The method of claim 9, wherein the UE is in communication with at least one of a mobile device, a network, and/or autonomous vehicles other than the UE.
